(19) United States
(12) Patent Application Publication
(10) Pub. No.: US 2013/0167637 A1
(43) Pub. Date: Jul. 4, 2013

(54) MICROELECTROMECHANICAL SYSTEM

(71) Applicant: Maxim Integrated Products, Inc., San Jose, CA (US)

(72) Inventor: Lorenzo Bertini, Pisa (IT)

(73) Assignee: MAXIM INTEGRATED PRODUCTS, INC., San Jose, CA (US)

(21) Appl. No.: 13/720,478

(22) Filed: Dec. 19, 2012

(30) Foreign Application Priority Data
Dec. 29, 2011 (DE) 10 2011 057 169.8

(51) Int. Cl. G01C 19/5712

(52) U.S. Cl. CPC G01C 19/5712
USPC 73/504.12

(57) ABSTRACT

A microelectromechanical system for detecting accelerations about or along an X-axis, Y-axis, and/or Z-axis, having a substrate and having a driving mass and a detection mass (1) disposed parallel to the substrate in an X-Y plane and mounted displaceably relative to the substrate. At least one slit (5) is disposed in the driving and/or detection mass (1) for compensating for distortions due to residual material stresses in the driving and/or detection mass (1).

### CROSS REFERENCE TO RELATED APPLICATIONS

The application claims the benefit of German Application Serial No. 10 2011 057 169.8, entitled “Mikroelektromechanisches System”, filed on Dec. 29, 2011, the subject matter of which is incorporated herein by reference.

### BACKGROUND

A. Technical Field

The present invention relates to a microelectromechanical system for detecting accelerations about or along an X-axis, Y-axis, and/or Z-axis, having a substrate and having a driving mass and a detection mass disposed parallel to the substrate in an X-Y plane and mounted displaceably relative to the substrate.

B. Background of the Invention

An MEMS resonator structure is known from WO 2009/079188 A1, wherein a driving and detection mass is disposed parallel to a substrate in an X-Y plane and is mounted displaceably relative to the substrate. The driving and detection mass comprises zones having different rigidity. It is thereby made possible that the driving and detection mass can be deformed in a targeted manner in order to allow the required motions for driving the mass and detecting movements of the sensor. In order to obtain zones of the driving and detection mass having different rigidity, said publication proposes that openings are made in the driving and detection mass. The shape, size, and arrangement of said openings cause the driving and detection mass to be more or less extensible and thereby able to approach to a greater or lesser degree the sensor elements associated therewith.

The openings proposed in said publication are indeed able to affect the rigidity. It is, however, disadvantageous that the driving and detection mass is subject to material stresses due to the production and the openings made therein, which can lead to an undesired deformation of the driving and detection mass. Said material stresses, under certain circumstances, cause the driving and detection mass to be insufficiently flat. Sensor elements that typically determine a distance between the driving and detection mass and the stationary substrate by means of a corresponding signal can thereby become inaccurate. The inaccuracy results from the fact that no clear signal indicating a particular distance is obtained, due to warping in the driving and detection mass.

### SUMMARY OF THE INVENTION

The object of the present invention is thus to ensure that, independent of the rigidity of the driving and/or the detection mass, the driving and/or the detection mass are as flat and undistorted as possible, at least in the region of the sensor elements measuring the distance.

The object is achieved by a microelectromechanical system having the features of claim 1.

A microelectromechanical system according to the invention serves for detecting accelerations about or along an X-axis, a Y-axis, and/or a Z-axis. It comprises a substrate and a driving mass and a detection mass disposed parallel to the substrate in an X-Y plane. The driving mass and the detection mass are mounted displaceably, in particular rotatably, relative to the substrate. The driving mass is typically driven at a predetermined frequency by means of electrodes. When the substrate is deflected about or along an X-axis, Y-axis, and/or Z-axis, depending on the arrangement, motion, and mounting of the driving mass and the detection mass, a Coriolis force causes a deflection of the driving mass and the detection mass. Electrodes disposed on the detection mass and on the substrate determine the deflection of the driving mass and the detection mass, by the fact that the distance between the electrodes and the sensor elements changes. The sensor electrodes are typically both connected to the substrate in a stationary manner, and disposed on the detection mass.

In order to accurately determine the distance between the detection mass and the substrate or the distance between the two sensor elements, it is substantial that the detection mass comprises a defined shape. If the detection mass has become deformed due to material stresses that remain from the production process, for example, or due to temperature effects, then the distance between the detection mass and the substrate or between the two sensor electrodes will not be able to be accurately determined in the initial neutral state nor in case of a deflection of the detection mass.

According to the invention, therefore, in order to compensate for distortions due to residual material stresses of the driving mass and/or detection mass, at least one slit is disposed in the driving mass and/or detection mass. The material stresses of the driving mass and/or detection mass are relieved by the slit, and the driving and detection mass is thereby aligned substantially flat and without distortion. The slit is either predetermined or individually applied in the structure in order to compensate for distortions.

The arrangement of the slit in the driving mass and/or detection mass is thereby effected such that corresponding distortions do not occur at all, or existing distortions are eliminated. Depending on the design of the driving mass and/or detection mass, it can either be applied at a predefined location or in a different position, according to the individual requirement. The advantage of the present invention is that material stresses of the driving mass and/or detection mass are relieved by the slits that are applied, and distortions caused thereby are thus eliminated. The driving and/or detection mass thereby becomes significantly flatter and possibly also less sensitive to temperature effects. The motions of the driving and detection masses are also thereby made more uniform in the directions provided. The slits can result in new, local distortions, but the driving mass and/or detection mass thus machined becomes flatter as a whole.

In an advantageous embodiment of the invention, the slit is aligned in the X-direction and/or in the Y-direction and/or in the X-Y direction. This makes production of the slit easier. The effect of the slit is also more predictable than for an arbitrary alignment of the slits. When using a plurality of slits, in such an arrangement said slits affect the stress relief of the driving and/or detection mass in a predictable manner.

If a plurality of slits are advantageously applied to the driving and/or detection mass, then said slits can also intersect each other. Slits that are joined crosswise are particularly advantageous, because they can relieve material stresses in a particularly effective manner. The slits can also be disposed on the driving and/or detection mass in a plurality of intersections.

A further advantage of the present invention is that the rigidity of the driving mass and/or detection mass is not negatively affected by the slits that are made. The slits serve solely for relieving residual material stresses. The rigidity of the driving mass and/or detection mass that is required for moving the corresponding mass in a predetermined manner is not thereby degraded, or at least not substantially.

In a particularly advantageous implementation of the invention, the slit is deep enough in the direction of the Z-axis to extend through the entire driving and/or detection mass. In a further embodiment of the invention, however, it can be advantageous that the slit has a depth that only partially corresponds to the thickness of the driving and/or detection mass. In some cases, this can be sufficient to relieve the material stress.

A plurality of holes are typically disposed in the driving and/or detection mass. Said holes are advantageous for producing the driving and detection mass, and additionally reduce the weight of the driving and detection mass. The holes can have nearly arbitrary shapes, such as round, square, rectangular, oval, or polygonal. The present invention can be implemented particularly advantageously if some of the holes are connected to each other by at least one slit. Stresses present in the webs between adjacent holes are relieved by separating said webs. The rigidity of the driving mass and/or detection mass is only insubstantially affected thereby, or not affected at all, and therefore has no negative effect on the functionality of the driving mass and/or detection mass.

It is advantageous if the slit has a width that is less than an edge length of the holes connected to each other. It is namely very frequently sufficient if only the web between adjacent holes is cut through. The width of said cut is typically of no significance for relieving stress. The remaining part of the web between two adjacent holes provides a certain contribution to the rigidity and total mass of the driving and/or detection mass. The characteristic of the microelectromechanical system is thereby only slightly affected, or not at all.

In particular if the slit is aligned in the X-Y direction, it is advantageous if the slit connects two vertices of adjacent holes. Alternatively, a slit can also cut through the two edge lengths of adjacent holes. It is critical that the material stress of the driving mass and/or detection mass is relieved by introducing the slit, and the driving and/or detection mass thereby extends in as flat a manner as possible.

If a plurality of slits are made in the driving and/or detection mass, then it can be advantageous if a plurality of non-slitted holes are disposed in the region between two adjacent slits extending in parallel. This particularly affects the rigidity of the driving and detection mass, which is not substantially reduced thereby.

The present invention can be used in microelectromechanical systems which are either a one-dimensional or multi-dimensional rate of rotation sensor and/or an acceleration sensor. It is critical that applying the slits according to the invention to the driving and/or detection mass causes distortions, such as undulations or torsions due to material stresses, to be relieved and the driving and/or detection mass extends in a substantially flat manner after the slits are made, even if individual, local distortions can continue to be present.

### BRIEF DESCRIPTION OF THE DRAWINGS

Further advantages of the present invention are described in the following exemplary embodiments. There is showing:

FIG. 1 a perspective view of a driving and detection mass having a plurality of slits,

FIG. 2 a detail from FIG. 1, in an enlarged view,

FIG. 3 a further magnified detail from FIG. 2, in a perspective view,

FIG. 4 a further embodiment of the present invention, and

FIG. 5 a further embodiment of the present invention.

### DETAILED DESCRIPTION OF THE PREFERRED EMBODIMENTS

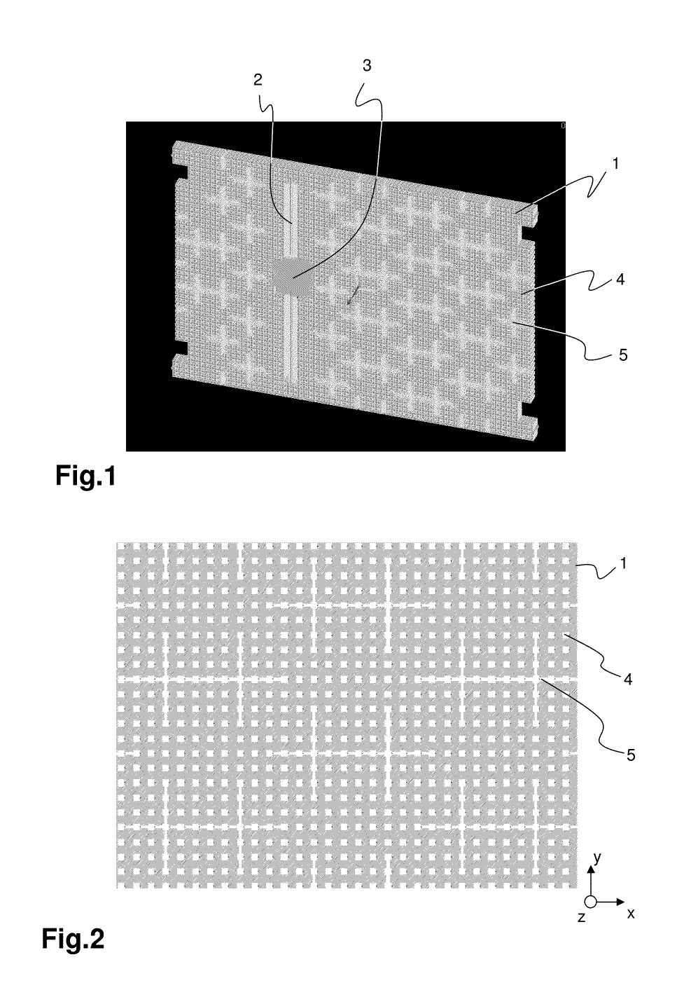

FIG. 1 shows a perspective view of a driving and detection mass 1 of a microelectromechanical system. The driving and detection mass 1 serves for detecting accelerations, for example, wherein the driving and detection mass 1 rotates about a rotational axis. The driving and detection mass 1 is shown here as a single, common mass. The invention, however, is advantageous for separate masses as well, wherein each mass fulfills only its own task, i.e. the driving mass drives the system and is deflected due to a Coriolis force in the event of acceleration of the system, and the detection mass, which in this case is deflected with the driving mass and serves for determining the magnitude of the deflection or acceleration. The shape of the driving and detection mass 1 can, of course, also be implemented differently.

The rotational axis is implemented by a torsional spring 2 rotatably attaching the driving and detection mass 1 to an anchor 3. The anchor 3 is shown only in a rough sketch. It can be designed differently. A single anchor or a plurality of anchors can thus be provided. The driving and detection mass 1 can rotate about a central anchor, be displaced linearly, or oscillate radially with respect to a mounting.

The anchor 3 is attached to a substrate (not shown). If the driving and detection mass 1, as shown here, is part of a Z-acceleration sensor, then in case of an acceleration in the Z-direction, that is, perpendicular to the driving and detection mass 1 and the substrate, the driving and detection mass 1 is tilted about the rotary axis. The distance between the driving and detection mass 1 with respect to the substrate below the same is thereby changed. Electrodes (not shown) located between the driving and detection mass 1 and the substrate can detect said change in distance by a change in an electrical signal and forward it to an analysis unit.

The driving and detection mass 1 has a plurality of holes 4 according to the present exemplary embodiment. The holes 4 in said embodiment example comprise a square cross section and protrude through the entire driving and detection mass 1. They perforate the driving and detection mass 1, so to speak. The production of the sensor can be relatively simple due to the holes, for example, using an etching process.

It is possible that material stresses are present in the driving and detection mass 1 due to the production or the configuration of the driving and detection mass 1, bringing about distortion or warping of the driving and detection mass 1. This leads to a non-uniform distance relative to the substrate, and thus to inaccurate measurement of both the output signal in the unaccelerated state of the sensor, and the modified signal in the case of an acceleration.

In order to eliminate said distortion, the driving and detection mass 1 shown has a plurality of slits 5. The slits 5 either extend through the entire driving and detection mass 1 in the Z-direction, or are present only at the surface, having a depth corresponding to only a partial thickness of the driving and detection mass 1. The slits 5 are aligned in the X-direction and the Y-direction, extending along the rows of a plurality of holes 4. They are implemented such that they cut through webs disposed between the holes 4, thus relieving material stresses of the driving and detection mass 1. Even though it is possible that small, local distortions arise due to the slits 5, the driving and detection mass 1 is nevertheless thereby straighter as a whole. The analysis of the signals of the electrodes disposed on the bottom side of the driving and detection mass 1 and of the opposite electrodes attached to the substrate thereby becomes substantially more accurate. The slits 5 in said embodiment example are distributed uniformly across the driving and detection mass 1. It is also possible, however, that they are disposed only locally, in order to relieve local stresses. The slits 5 are disposed crosswise, wherein some of the crosses are also connected to each other, so that double crosses or H-shaped slits are formed.

FIG. 2 shows a detail from FIG. 1. It is evident that a plurality of holes 4 are distributed uniformly in rows over the surface of the driving and detection mass 1. The slits 5 are distributed such that they connect individual adjacent holes 4 to each other. This results in crosswise slits 5 in the present exemplary embodiment. The width of the slits 5 can be different. It should be ensured in any case that the slits 5 comprise a width such that the remaining material on both sides of the slit 5 no longer makes contact when displacement of the driving and detection mass occurs, in order to prevent snagging or friction that could lead to errors in the measurement result. Overall, the slits 5 should be distributed over the surface of the driving and detection mass 1, such that the rigidity of the driving and detection mass 1 is not affected, or not substantially. They are provided only so that the material stresses arising from its production or a temperature effect on the sensor are prevented or eliminated.

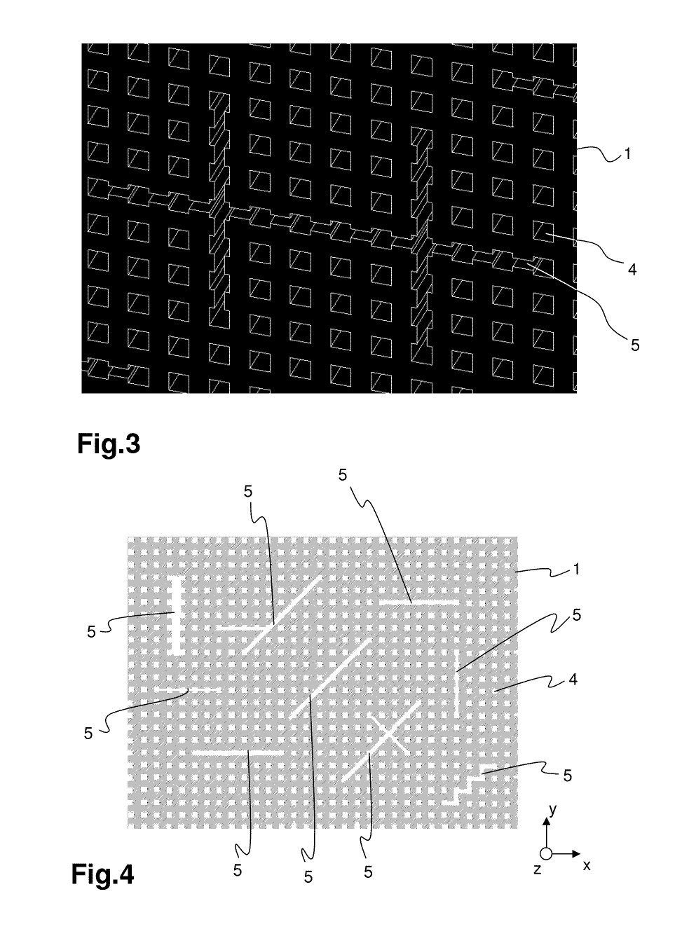

FIG. 3 shows a further enlarged view of FIG. 2 in perspective view. It can be seen that the slits 5 connect adjacent holes 4 to each other, by the edges of the holes 4 being partially cut through. The slits 5 comprise a width that is less than the edge length of the hole 4. A plurality of slits 5 are disposed crosswise to each other, wherein the transverse beams of two adjacent crosses are aligned.

FIG. 4 shows further exemplary embodiments showing how the slits 5 can be disposed on the surface of the driving and detection mass 1. It can be seen that they connect the holes 4 via their vertices, that they are more or less thick, that they can also be disposed without intersecting each other, or can have forked or stepped designs. It is further possible to disposed a slit 5 such that the entire web between two adjacent rows of holes 4 is removed. The variants of slits shown here are, of course, not exclusive.

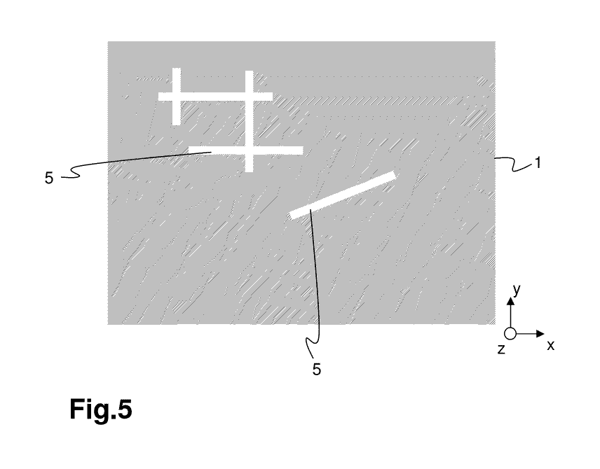

A further exemplary embodiment of the present invention is shown in FIG. 5. The driving and detection mass 1 has no holes 4, but rather has a complete surface. Nevertheless, various slits 5 are present within the projection surface of the driving and detection mass 1, which are shown here as examples and are not exclusive. It can be seen that a plurality of slits 5 extending parallel to each other can also intersect one another. Slits 5 extending at an acute angle to the X-axis or Y-axis can also be used. The purpose of each of said slits 5 is to relieve material stresses and overall to allow the driving and detection mass 1 to extend in as straight and stress-free a manner as possible within the X-Y plane.

The invention is not limited to the embodiments shown. Other shapes of holes 4 and slits 5 are also possible. The driving and detection masses can also be implemented differently than shown here. The depth of the slits 5 is variable, wherein they protrude only partially into the depth of the driving and detection mass 1 or can also completely cut through the driving and detection mass 1.

### REFERENCE LIST

1 Driving and detection mass
2 Torsional spring
3 Anchor
4 Hole
5 Slit

1. A microelectromechanical system for detecting accelerations about or along at least one axis among an X-axis, Y-axis and Z-axis, comprising:
a substrate,
a driving mass; and
a detection mass disposed parallel to the substrate in an X-Y plane and mounted displaceably relative to the substrate; and
wherein at least one slit is disposed in at least one mass of the driving mass and the detection mass for compensating for distortions due to residual material stresses in the at least one mass.

2. The microelectromechanical system according to claim 1, wherein the at least one slit is aligned one direction selected from the X-direction, the Y-direction and an X-Y direction.

3. The microelectromechanical system according to claim 1, wherein a plurality of slits are connected to each other in a crosswise manner.

4. The microelectromechanical system according to claim 1, wherein the at least one slit comprises a depth in the direction of the Z-axis corresponding entirely or partially to the thickness of the at least one mass.

5. The microelectromechanical system according to claim 1, wherein the at least one mass comprises a plurality of holes, and that some of the plurality of holes are connected to each other by the at least one slit.

6. The microelectromechanical system according to claim 1, wherein the at least one slit comprises a width that is less than an edge length of the plurality of holes connected to each other.

7. The microelectromechanical system according to claim 1, wherein the at least one slit connects together two edges or two vertices of adjacent holes.

8. The microelectromechanical system according to claim 1, wherein two slits are disposed adjacently and in parallel to each other in the at least one mass, and a plurality of holes without slits are disposed in the region between these two adjacent and parallel slits.

9. The microelectromechanical system according to claim 1, wherein the microelectromechanical system is a one-dimensional or multi-dimensional inertial sensor selected from a rate of rotation sensor acceleration sensor.
